(19) United States
(12) Patent Application Publication
(10) Pub. No.: US 2015/0346767 A1
(43) Pub. Date: Dec. 3, 2015

(54) WEARABLE ELECTRONIC DEVICE

(71) Applicants: SHENZHEN FUTAIHONG PRECISION INDUSTRY CO., LTD., Shenzhen (CN); FIH (HONG KONG) LIMITED, Kowloon (HK)

(72) Inventors: NAI-LIN YANG, New Taipei (TW); BING ZHANG, Shenzhen (CN); QIANG WANG, Shenzhen (CN); SHAO-LIN YANG, Shenzhen (CN); WEN-BIN SUN, Shenzhen (CN)

(21) Appl. No.: 14/551,825

(22) Filed: Nov. 24, 2014

(30) Foreign Application Priority Data
May 30, 2014 (CN) 201410236871.3

(51) Int. Cl. G06F 1/16

(52) U.S. Cl. CPC G06F 1/163; G06F 1/1637

(57) ABSTRACT

A wearable electronic device includes a first housing, a second housing, an electronic module, and a connecting member. The second housing is detachably assembled to the first housing. The electronic module is received in a receiving space between the first and second housings. The connecting member is attached to one of the first and second housings.

### CROSS-REFERENCE TO RELATED APPLICATION

This application is related to co-pending U.S. Patent Application (Attorney Docket No. US57070), entitled “WEARABLE ELECTRONIC DEVICE”, and invented by Yang et al. The related application has the same assignee as the present application and has been concurrently filed herewith. The above-identified application is incorporated herein by reference.

### FIELD

The disclosure generally relates to wearable electronic devices, and particularly to a wearable electronic device having a changeable appearances.

### BACKGROUND

Electronic devices are commonplace throughout most of the world today. Advancements in integrated circuit technology have enabled the development of electronic devices that are sufficiently small and lightweight. Wearable electronic devices such as smart watches, smart eyeglasses, electronic rings, etc. appear and become popular because of the convenience of carrying and using. The wearable electronic devices are mostly attached or coupled to the wrist, neck and face of users. Except for pursuing of multifunction of the wearable electronic devices, the users also pay more attention to their appearance. However, a housing of the wearable electronic devices are commonly enclosed and undetectable. Thus, it is difficult for the users to obtain a new appearance by changing the housing.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a perspective, diagrammatic view of a wearable electronic device, according to an exemplary embodiment.

FIG. 2 is a disassembled view of the wearable electronic device of FIG. 1.

FIG. 3 is similar to FIG. 1, but shown from another angle.

FIG. 4 is a disassembled view of an electronic module of the wearable electronic device of FIG. 1.

FIG. 5 is similar to FIG. 4, but shown from another angle.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

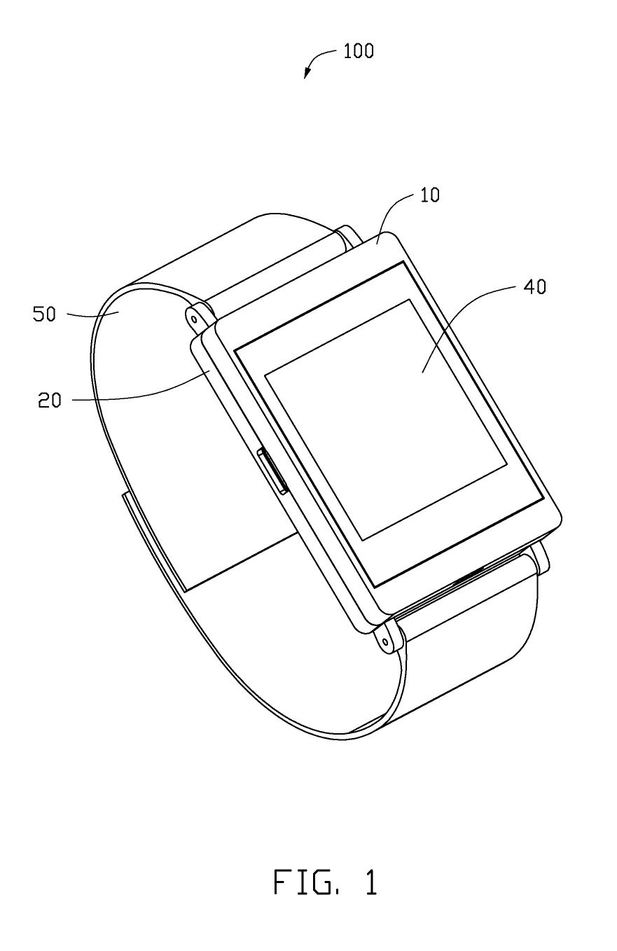

FIG. 1 is a perspective, diagrammatic view of a wearable electronic device 1, according to an exemplary embodiment. The electronic device 100 may be a smart watch, a health bracket, or smart pendant. The wearable electronic device 100 includes a first housing 10, a second housing 20, an electronic module received between the first housing 10 and the second housing 20, and a connecting member 50 assembled to one of the first and second housings 10, 20 for users to carry the electronic device 100.

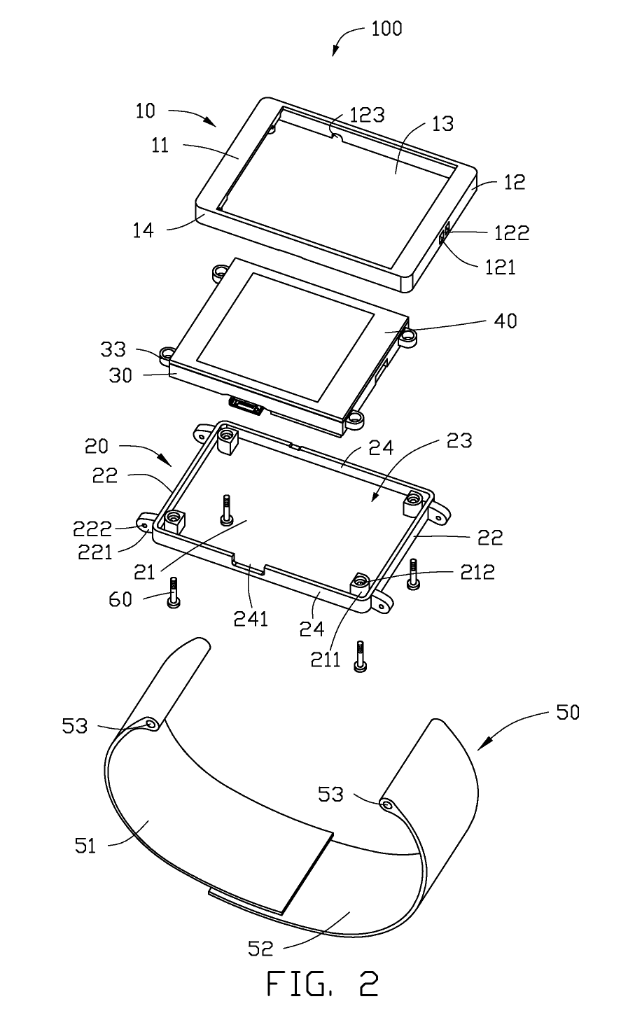

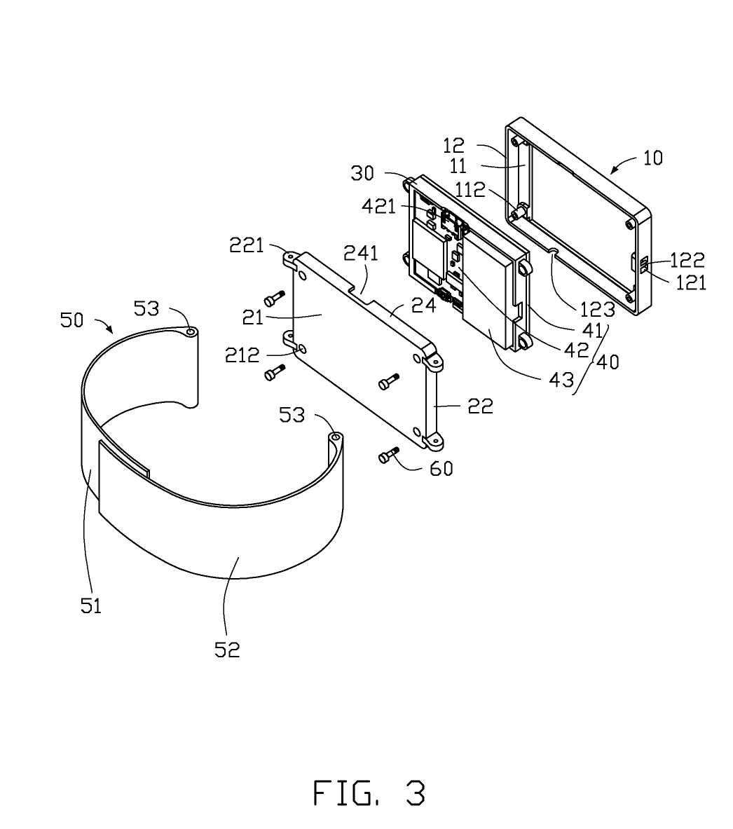

FIGS. 2 and 3 show that, the first housing 10 is substantially rectangular. The first housing 10 includes a top wall 11, two opposite first end walls 12, and two opposite first sidewalls 14. The first end walls 12 and the first sidewalls 14 are perpendicularly extended from peripheral edges of the top wall 11 and surrounding the top wall 11 to cooperatively form a first receiving cavity 13. A hollow positioning post 112 protrudes from each corner of the first receiving cavity 13. A recess 121 is defined in one of the first end walls 12. A rib 122 spans over the recess 121 for hinging the electronic device 100. A first cutout 123 is defined in one of the first sidewalls 14.

The second housing 20 is also substantially rectangular and corresponds to the first housing 10. The second housing 20 includes a bottom wall 21, two opposite second end walls 22, and two opposite second sidewalls 24. The second end walls 22 and the second sidewalls 24 are perpendicularly extended from peripheral edges of the bottom wall 21 and surrounding the bottom wall 21 to cooperatively form a second receiving cavity 23. A receiving post 211 protrudes from each corner of the second receiving cavity 23 corresponding to the positioning posts 112. A receiving hole 212 is defined in each receiving post 211 through the bottom wall 21. At least one connecting portion 221 perpendicularly protrudes from an outer surface of each second end walls 22. In this exemplary embodiment, there are two connecting portions 221 perpendicularly protruding from each second end wall 22 at two ends of each second end wall 22. A connecting hole 222 is defined in each connecting portion 221. A strip-shaped second cutout 241 is defined in one of the second sidewalls 24.

The electronic module includes a case 30 and an electronic assembly 40 received in the case 30.

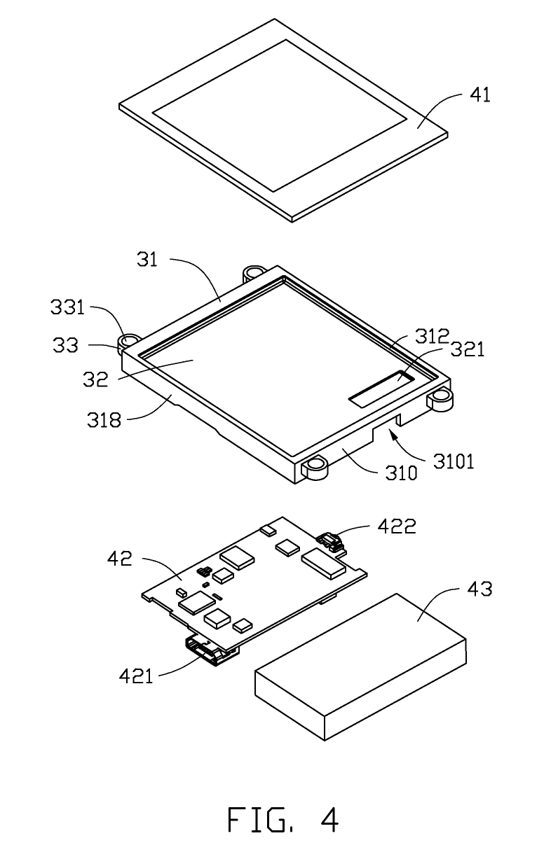

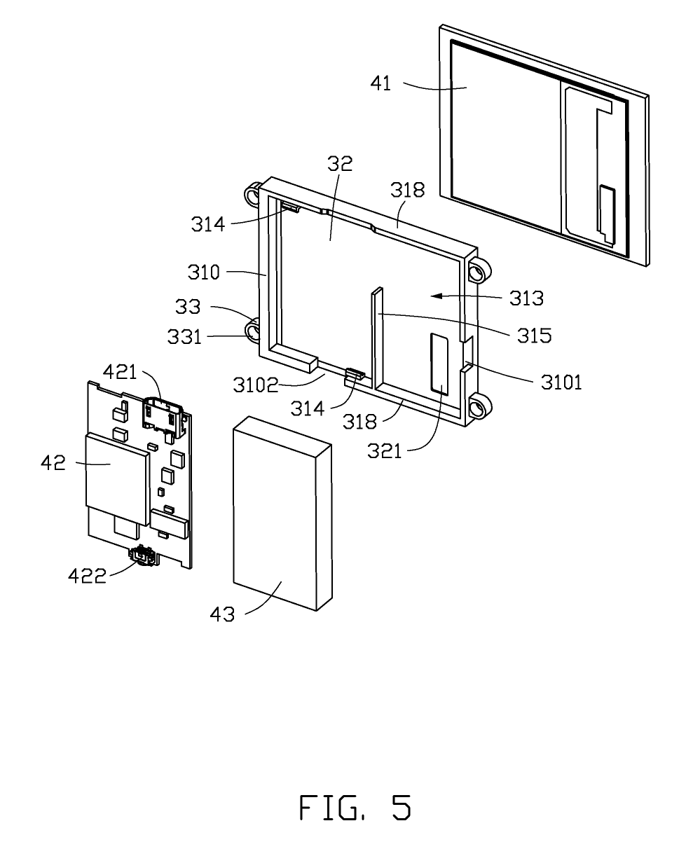

FIGS. 4 and 5 show that, the case 30 includes a receiving frame 31 and a dividing plate 32 integrated with the receiving frame 31. The receiving frame 31 is substantially rectangular and includes two opposite end portions 310 and two opposite side portions 318 connected to the end portions 310. The dividing plate 32 is received in the receiving frame 31 and fixedly connected to the end portions 310 and the side portions 318. The dividing plate 32 divides the receiving frame 31 into a first receiving chamber 312 and a second receiving chamber 313.

At least one positioning tab 33 protrudes from each end portion 310 corresponding to the receiving posts 211 and the positioning posts 112. A positioning hole 331 is defined in each positioning tab 33. A first slot 3101 and a second slot 3102 are defined in one of the end portions 310 and one of the side portions 318, respectively. A latching portion 314 protrudes from an inner surface of one of the side portions 318 and is adjacent to the second slot 3102. The latching portion 314 may be a hook, an elastic sheet, a projecting block, etc. In this exemplary embodiment, the latching portion 314 is a hook.

A substantial strip-shaped supporting plate 315 perpendicularly extends from the inner surface of one of the side portions 318 and parallel to the two end portions 310. A through hole 321 is defined in the dividing plate 32 at an end of the dividing plate 32.

The electronic assembly 40 includes a display unit 41, a control unit 42, and a power supply unit 43 electronically connected to each other. The display unit 41 is received in the first receiving chamber 312. The control unit 42 and the power supply unit 43 are received in the second receiving chamber 313. The display unit 41 may electronically connect to the control module 42 by flexible flat cables extending through the through hole 321. The control unit 42 includes an interface 421 and a switch 422. The switch 422 is exposed from the second slot 3102.

The connecting member 50 includes a first wrist band 51 and a second wrist band 52. The first and second wrist bands 51, 52 respectively define a pivotal hole 53 at one end of the first and second wrist bands 51, 52. Two shafts (not shown) extend through the pivotal holes 53 and the corresponding connecting holes 222 to pivotally connect the first and second wrist bands 51, 52 to the second housing 20. In another embodiment, the connecting member 50 may be pivotally connected to the second housing 20 by screws, bolts, etc. The other ends of the first and second wrist bands 51, 52 can be fixed together or separated from each other to enable the connecting member 50 to be carried on the wrist of a user.

In addition, the connecting member 50 may be a necklace or neck strap extending through the recess 121 and hinging on the rib 122. Thus, the connecting member 50 enables the electronic device 100 to be carried about the neck of a user.

In assembly, the display unit 41 is fixedly received in the first receiving chamber 312. The control unit 42 and the power supply unit 43 are fixedly received in the second receiving chamber 313 and positioned at two side of the supporting plate 315. The latching portion 314 is latched to an edge of the control unit 42 to prevent the control unit 42 from escaping from the second receiving chamber 313. Therefore, the electronic assembly 40 is assembled to the case 30 and forms the electronic module. The assembled electronic module is received in the second receiving cavity 23 with the positioning tabs 33 aligning with the receiving posts 211. The first housing 10 covers the electronic module with the positioning posts 112 aligning with the positioning tabs 33 and the receiving posts 211. Therefore, the electronic module is received in a receiving space between the first and second housing 10, 20 with the switch 422 and the interface 421 exposed from the first and second cutouts 123, 241, respectively. The first and second housing 10, 20 may be fixed together by friction between the first and second housings 10, 20.

In another embodiment, the electronic device 100 may further include a plurality of fastening members 60 such as screws. Each fastening member 60 extends through one of the receiving post 212, the positioning tab 33, and the positioning post 112 and fastens the first and second housings 10, 20 together.

In addition, the first and second housings 10, 20 can be designed to be circle, heart-shaped, etc. Therefore, the electronic device 100 can obtain different appearances by detaching and exchanging the first and second housings 10, 20 to satisfy different requirements of the user.

It is to be understood, however, that even through numerous characteristics and advantages of the present disclosure have been set forth in the foregoing description, together with details of assembly and function, the disclosure is illustrative only, and changes may be made in the details, especially in the matters of shape, size, and arrangement of parts within the principles of the disclosure to the full extent indicated by the broad general meaning of the terms in which the appended claims are expressed.

What is claimed is:

1. A wearable electronic device comprising:
a first housing;
a second housing detachably assembled to the first housing;
an electronic module received in a receiving space between the first and second housings; and
a connecting member attached to one of the first and second housings.

2. The wearable electronic device of claim 1, wherein the electronic module comprises a case and an electronic assembly received in the case; the case comprises a receiving frame and a dividing plate fixedly connected to the receiving frame, the dividing plate divides the receiving frame into a first receiving chamber and a second receiving chamber.

3. The wearable electronic device of claim 2, wherein the electronic assembly comprises a display unit, a control unit, and a power supply unit electronically connected to each other; the display unit is received in the first receiving chamber, the control unit and the power supply unit are received in the second receiving chamber.

4. The wearable electronic device of claim 2, wherein the first housing comprises a top wall, two opposite first end walls, and two opposite first sidewalls, the first end walls and the first sidewalls are perpendicularly extended from peripheral edges of the top wall and surrounding the top wall to cooperatively form a first receiving cavity; the second housing comprises a bottom wall, two opposite second end walls, and two opposite second sidewalls, the second end walls and the second sidewalls are perpendicularly extended from peripheral edges of the bottom wall and surrounding the bottom wall to cooperatively form a second receiving cavity, the first and second receiving cavities form the receiving space.

5. The wearable electronic device of claim 4, further comprising at least one fastening member; wherein the first receiving cavity comprises at least one positioning post, the second receiving cavity comprises at least one corresponding receiving post aligning with the at least one positioning post; the at least one fastening member extends through the at least one positioning post and the at least one corresponding receiving post and fastens the first and second housings together.

6. The wearable electronic device of claim 5, wherein the case comprises at least one positioning tab, the at least one positioning tab defines a positioning hole corresponding to the at least one positioning post and the at least one corresponding receiving post; the at least one fastening member extends through the at least one positioning post, the positioning hole and the at least one corresponding receiving post and fastens the first and second housings and the case together.

7. The wearable electronic device of claim 1, wherein the first housing defines a recess, and comprises a rib spanning over the recess, the connecting member extends through the recess and hinges on the rib.

8. The wearable electronic device of claim 1, wherein the second housing comprises two connecting portions protruding from two ends of the second housing; the connecting member comprises a first and second wrist bands connected to the connecting portions, respectively.

9. A wearable electronic device comprising:
a first housing;
a second housing;
at least one fastening member fastening the first and second housings together;
an electronic module received in a receiving space between the first and second housings; and
a connecting member attached to one of the first and second housings.

10. The wearable electronic device of claim 9, wherein the first housing comprises at least one positioning post, the second housing comprises at least one corresponding receiving post aligning with the at least one positioning post, the at least one fastening member extends through the at least one positioning post and the at least one corresponding receiving post.

11. The wearable electronic device of claim 10, wherein the electronic module comprises a case and an electronic assembly received in the case; the case comprises at least one positioning tab, the at least one positioning tab defines a positioning hole corresponding to the at least one positioning post and the at least one corresponding receiving post; the at least one fastening member extends through the at least one positioning post, the positioning hole and the at least one corresponding receiving post and fastens the first and second housings and the case together.

12. The wearable electronic device of claim 10, wherein the case further comprises a receiving frame and a dividing plate fixedly connected to the receiving frame, the dividing plate divides the receiving frame into a first receiving chamber and a second receiving chamber; the electronic assembly comprises a display unit, a control unit, and a power supply unit electronically connected to each other; the display unit is received in the first receiving chamber, the control unit and the power supply unit are received in the second receiving chamber.

13. The wearable electronic device of claim 9, wherein the first housing comprises a top wall, two opposite first end walls, and two opposite first sidewalls, the first end walls and the first sidewalls are perpendicularly extended from peripheral edges of the top wall and surrounding the top wall to cooperatively form a first receiving cavity; the second housing comprises a bottom wall, two opposite second end walls, and two opposite second sidewalls, the second end walls and the second sidewalls are perpendicularly extended from peripheral edges of the bottom wall and surrounding the bottom wall to cooperatively form a second receiving cavity, the first and second receiving cavities form the receiving space.

14. The wearable electronic device of claim 9, wherein the first housing defines a recess, and comprises a rib spanning over the recess, the connecting member extends through the recess and hinges on the rib.

15. The wearable electronic device of claim 9, wherein the second housing comprises two connecting portions protruding from two ends of the second housing; the connecting member comprises a first and second wrist bands connected to the connecting portions, respectively.
